(19) United States
(12) Patent Application Publication
(10) Pub. No.: US 2007/0222366 A1
(43) Pub. Date: Sep. 27, 2007

(54) DISPLAY DEVICE AND METHOD THEREOF

(75) Inventors: Kyong-tae Park, Uijeongbu-si (KR); Si-duk Sung, Seoul (KR); Dae-jin Park, Incheon (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/687,799

(22) Filed: Mar. 19, 2007

(30) Foreign Application Priority Data
Mar. 24, 2006 (KR) 1020060027054

(51) Int. Cl. H05B 33/06; H05B 33/08

(52) U.S. Cl. 313/500; 313/505

(57) ABSTRACT

A display device including an insulating substrate including a display region, a light emitting layer formed within the display region, a plurality of voltage pads formed in a non-display region of the insulating substrate and supplying a predetermined voltage to the display region, a circuit board connected with a lateral side of the insulating substrate and outputting a voltage to be supplied to the voltage pads, and a printed circuit film connecting the voltage pads and the circuit board. The printed circuit film is partially overlapped with the display region.

This application claims priority to Korean Patent Application No. 2006-0027054, filed on Mar. 24, 2006, and all the benefits accruing therefrom under 35 U.S.C. §119, the contents of which are incorporated herein by reference in its entirety.

### BACKGROUND OF THE INVENTION

1. Field of the Invention

The present invention relates to a display device, and more particularly, to a display device which is capable of being stably supplied with a driving voltage or a common voltage.

2. Description of the Related Art

An organic light emitting diode (“OLED”) has been popular since it is driven through a low voltage, is relatively light and small, has a wide viewing angle and responds with relatively high speed. The OLED includes a plurality of active thin film transistors provided on an OLED substrate. An anode electrode forming a pixel and a cathode electrode as a reference voltage are formed on the thin film transistors. When a voltage is applied between the anode and cathode electrodes, a hole and an electron are combined to create an exciton. The exciton falls to a ground state in a light emitting layer which is formed between the anode and cathode electrodes, thereby emitting light.

The OLED displays images by controlling the emitting light. A switching transistor is formed on an intersection made by a gate line and a data line in the OLED substrate to form a single pixel. A driving transistor is formed on the OLED substrate and connected with a driving voltage line which supplies a driving voltage. Two voltage supplying pads are formed in the OLED substrate. One of the voltage supplying pads supplies a common voltage as a reference voltage to the cathode electrode, and the other of the voltage supplying pads supplies a driving voltage to the driving voltage line.

The common voltage and driving voltage should be sufficiently supplied to a display device as the number of pixels increases to realize a relatively wide screen and high resolution.

### BRIEF SUMMARY OF THE INVENTION

An exemplary embodiment provides a display device which is supplied with a driving voltage or a common voltage efficiently and provides uniform brightness.

An exemplary embodiment provides a display device including an insulating substrate including a display region, a light emitting layer formed within the display region, a plurality of voltage pads formed in a non-display region of the insulating substrate and supplying a predetermined voltage to the display region, a circuit board connected with a lateral side of the insulating substrate and outputting a voltage to be supplied to the voltage pads, and a printed circuit film connecting the voltage pads and the circuit board and partially overlapping with the display region.

In an exemplary embodiment, the display device further includes a gate line and a data line formed within the display region, a plurality of gate drivers formed in the non-display region and supplying a gate voltage to the gate line, and a plurality of data drivers formed in the non-display region and supplying a data voltage to the data line. The gate drivers and the data drivers are formed on the insulating substrate.

In an exemplary embodiment, a first voltage pad is formed between the plurality of gate drivers, and a second voltage pad is formed between the plurality of data drivers.

In an exemplary embodiment, one of the voltage pads extends along a longitudinal side of the display region.

In an exemplary embodiment, the printed circuit film contacts at least two parts of each of the voltage pads.

In an exemplary embodiment, the printed circuit film contacts at least two parts of each of the voltage pads.

In an exemplary embodiment, the display device further includes a driving voltage line formed within the display region. The voltage outputted to the voltage pads includes a driving voltage supplied to the driving voltage line.

In an exemplary embodiment, the display device further includes a common electrode formed on an upper surface of the display region. The voltage outputted to the voltage pad includes a common voltage supplied to the common electrode.

In an exemplary embodiment, the display device further includes an anisotropic conductive film formed between the voltage pads and the printed circuit film, and between the printed circuit film and the circuit board.

In an exemplary embodiment, the printed circuit film is formed on a side of the insulating substrate opposite to an emitting direction of light from the light emitting layer.

In an exemplary embodiment, the display device further includes a glass layer formed on the light emitting layer. The light from the light emitting layer is emitted towards the insulating substrate and the printed circuit film is provided on the glass layer.

In an exemplary embodiment, the display device further includes a glass layer formed on the light emitting layer. The light from the light emitting layer is emitted towards the glass layer and the printed circuit film is provided on a rear part of the insulating substrate.

In an exemplary embodiment, the printed circuit film includes a contacting part contacting the voltage pads, a bending part bent from the contacting part toward the rear part of the insulating substrate and a signal transmitter extending from the bending part along the rear part of the insulating substrate.

An exemplary embodiment provides a display device including an insulating substrate, a plurality of voltage pads formed on the insulating substrate and spaced from each other along a circumference of the insulating substrate, a voltage supplying part connected with the circumference of the insulating substrate and supplying a predetermined voltage to the voltage pads, and a plurality of voltage transmitting parts connecting the voltage pads and the voltage supplying part.

In an exemplary embodiment, the voltage transmitting parts include a printed circuit film.

An exemplary embodiment provides a display device including an insulating substrate including a display region, a light emitting layer formed within the display region, a plurality of voltage pads formed in a non-display region of the insulating substrate and supplying a predetermined voltage to the display region, a circuit board connected to a side part of the insulating substrate and outputting a voltage to the voltage pads, and a printed circuit film simultaneously transmitting the voltage outputted from the circuit board to the plurality of voltage pads.

In an exemplary embodiment, the printed circuit film connects the voltage pads and the circuit board, and is overlapped with the display region.

In an exemplary embodiment, the voltage supplied to the voltage pads includes at least one of a driving voltage and a common voltage.

In an exemplary embodiment, the display device further includes an anisotropic conductive film provided between the voltage pads and the printed circuit film, and between the printed circuit film and the circuit board.

In an exemplary embodiment, the printed circuit film is provided on a side of the insulating substrate opposite to an emitting direction of light from the light emitting layer.

An exemplary embodiment provides a method of forming a display device. The method includes forming a light emitting layer in a display region of an insulating substrate, forming a plurality of voltage pads in a non-display region of the insulating substrate, the plurality of voltage pads supplying a predetermined voltage to the display region, connecting a circuit board to the non-display region of the insulating substrate, the circuit board outputting a voltage to the voltage pads, and connecting a printed circuit film between the plurality of voltage pads and the circuit board, the printed circuit film overlapping the display region.

### BRIEF DESCRIPTION OF THE DRAWINGS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

The above and/or other aspects and advantages of the present invention will become apparent and more readily appreciated from the following description of the embodiments, taken in conjunction with the accompanying drawings of which:

FIG. 1 is a schematic view of an exemplary embodiment of a display device according to the present invention;

FIG. 2 is a cross-sectional view of the display device taken along line II-II in FIG. 1;

FIG. 3 is an equivalent circuit diagram of an exemplary embodiment of a pixel according to the present invention;

FIG. 4 is a schematic view of another exemplary embodiment of a display device according to the present invention;

FIG. 5 is a rear view of the display device of FIG. 4; and

FIG. 6 is a cross-sectional view of the display device taken along line VI-VI in FIG. 4.

### DETAILED DESCRIPTION OF INVENTION

Hereinafter, embodiments of the present invention will be described with reference to the accompanying drawings, wherein like numerals refer to like elements and repetitive descriptions will be avoided as necessary.

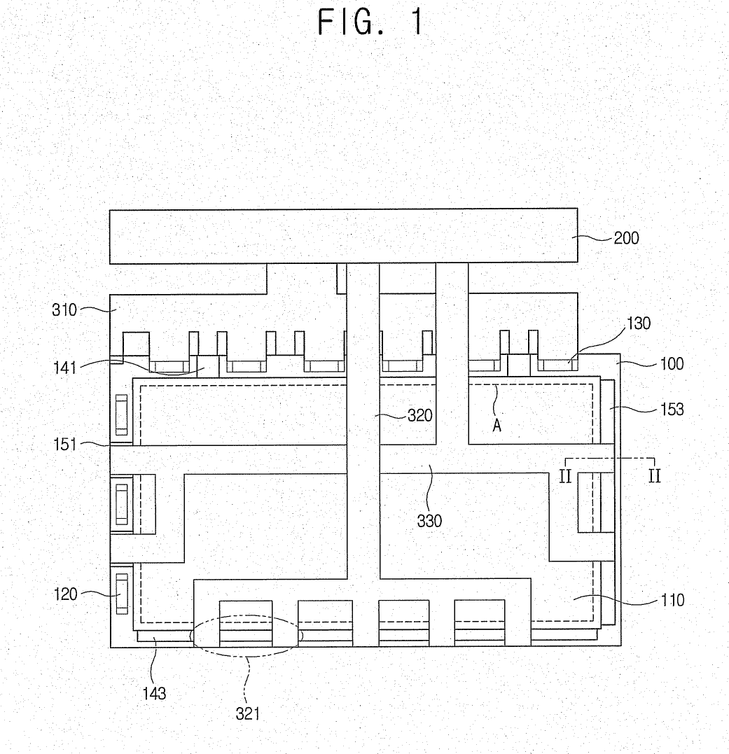

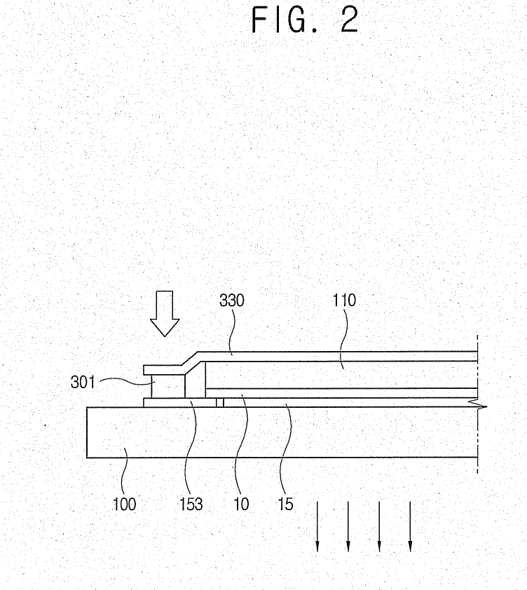

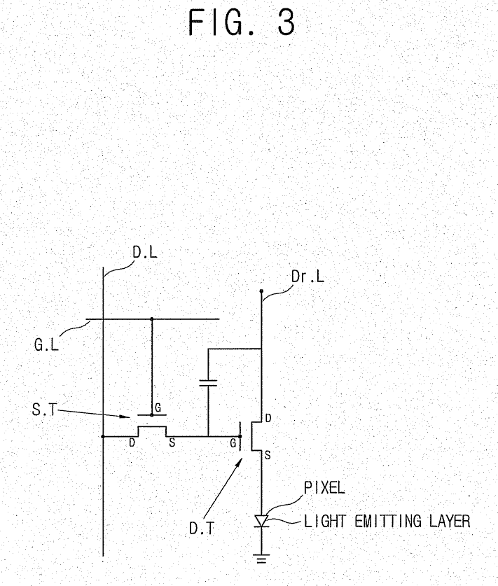

FIG. 1 is a schematic view of an exemplary embodiment of a display device according to the present invention. FIG. 2 is a cross-sectional view of the display device taken along line II-II in FIG. 1. FIG. 3 is an equivalent circuit diagram of an exemplary embodiment of a pixel according to the present invention.

Referring to FIGS. 1 to 3, a display device includes an insulating substrate 100 having a substantially rectangular shape and formed with a display region A, and a printed circuit board 200 which is connected with a lateral side of the insulating substrate 100. An encapsulation member 110, such as a glass layer, is formed on the insulating substrate 100 of a region corresponding to the display region A to reduce or effectively prevent the introduction of moisture or air to a light emitting layer, considered a display element. Reducing the moisture or air thereby protects the light emitting layer from being deteriorated.

A gate driver 120 and a data driver 130 are formed in a non-display region disposed on a region outside of the display region A of the insulating substrate 100. The gate driver 120 and data driver 130 are formed on a peripheral region of the insulating substrate 100. A plurality of voltage pads 141, 143, 151 and 153 is formed along sides of the display region A (e.g., in a non-display region). The voltage pads 141, 143, 151 and 153 may be formed along each of four sides of the display region A, but the invention is not limited thereto. The plurality of voltage pads 141, 143, 151 and 153 is connected with the printed circuit board 200 by a plurality of printed circuit films 310, 320 and 330. In exemplary embodiments, the printed circuit films 310, 320 and 330 may include a flexible printed circuit (“FPC”).

The display device further includes a common electrode (not shown) which is formed on the display region A between the insulating substrate 100 and the glass layer 110.

A gate line (not shown), a data line (not shown) and a driving voltage line (not shown) extended in a direction perpendicular to the gate line and a plurality of pixels having rectangular shapes defined by an intersection made by the gate line and the data line or the driving voltage line, are formed in the display region A in FIG. 1. The driving voltage line is formed parallel with the data line. In exemplary embodiments, the driving voltage line includes a metal layer and is formed in the same layer as the data line. The data line may include a data metal layer.

Hereinafter, an equivalent circuit of an exemplary embodiment of the pixel formed below the common electrode will be described with reference to FIG. 3.

A single pixel includes a switching transistor S.T which is electrically connected with the gate line G.L and the data line D.L, a driving transistor D.T which is electrically connected with a source electrode S of the switching transistor S.T and the driving voltage line Dr.L, and a pixel electrode “PIXEL” which is connected with the driving transistor D.T physically and electrically. In an exemplary embodiment, the pixel further includes a light emitting layer (not shown) which emits light by a voltage supplied from the pixel electrode.

The gate lines G.L are provided in parallel with each other and define a single pixel by crossing the data line D.L and the driving voltage line Dr.L. In exemplary embodiments, a gate metal layer which includes the gate line G.L and a gate electrode G of the switching transistor S.T and the driving transistor D.T may include a single or double layer. The gate line G.L supplies an on/off voltage to the switching transistor S.T connected with the gate line G.L.

The gate metal layer is insulated from the data metal layer. In an exemplary embodiment, the data metal layer includes the data line D.L crossing the gate line G.L, the drain electrodes D and the source electrodes S of each of the switching transistor S.T and the driving voltage transistor D.T. The data line D.L supplies a data voltage to the switching transistor S.T.

The driving voltage line Dr.L is provided in parallel with the data line D.L and crosses the gate line G.L to form a pixel in a substantially matrix shape. In exemplary embodiments, the driving voltage line Dr.L includes the data metal layer and may be formed in the same layer as the data line D.L. The driving voltage line Dr.L may be arranged in each pixel, but alternatively, two pixels may share a single driving voltage line Dr.L. When two pixels share a single driving voltage line Dr.L, the two pixels which are adjacent to the driving voltage line Dr.L may receive the driving voltage through a single driving voltage line. Advantageously, production processes can be simplified and can lessen an effect from an electro magnetic interference.

The switching transistor S.T includes a gate electrode G which is a part of the gate line G.L, a drain electrode D branched from the data line D.L, the source electrode S disposed separate from the drain electrode D, and a semiconductor layer (not shown) which is formed between the drain electrode D and the source electrode S. A gate on voltage from the gate line G.L is transmitted to the gate electrode G of the switching transistor S.T. Then, the data voltage from the data line D.L is supplied to the source electrode S through the drain electrode D.

The driving transistor D.T controls a data voltage supplied to the gate electrode G and the driving voltage supplied to the drain electrode D so as to control a voltage supplied to the pixel electrode.

The pixel electrode PIXEL becomes an anode to supply a hole to the light emitting layer. The common electrode formed across the display region A becomes a cathode to supply an electron. When a voltage is applied between the pixel electrode and the common electrode, the hole and the electron are combined with each other to create an exciton. The exciton falls to a ground state in the light emitting layer between the pixel electrode and the common electrode, and emits light.

A current in the light emitting layer increases as voltage difference between the gate electrode G and the source electrode S of the driving transistor D.T becomes larger. The current flowing in the light emitting layer is drained through the common electrode.

Returning to FIG. 1, the gate driver 120 and the data driver 130 are formed in a lateral (e.g., peripheral) part of the non-display region. The gate driver 120 is connected with an end part of the gate line. The data driver 130 is connected with an end part of the data line. The gate driver 120 and the data driver 130 supply various driving signals received to the gate line and the data line, respectively. In the illustrated embodiment, the gate driver 120 and the data driver 130 are mounted on the insulating substrate 100 with a chip on glass (“COG”) method, but the invention is not limited thereto.

The gate line and the data line within the display region A are connected with the gate driver 120 and the data driver 130. A gate fan-out part (not shown) and a data fan-out part (not shown) are formed on a place where the gate line and the data line are connected with the gate driver 120 and the data driver 130, such as between an end portion of the gate line and the data line, and the gate driver and the data driver, respectively. A wiring interval of the extended gate line becomes narrower in the gate fan-out part. Also, a wiring interval of the extended data line becomes narrower in the data fan-out part.

The driving voltage pads 141 and 143 connected with an end part of the driving voltage line, and the common voltage pads 151 and 153 electrically connected with the common electrode are formed in the non-display region. The display region A has a substantially rectangular shape similar to (e.g., corresponding in shape to) that of the insulating substrate 100. The voltage pads 141, 143, 151 and 153 are formed along an outside circumference of the display region A.

The driving voltage pads 141 and 143 include a first driving voltage pad 141 which is formed between a pair of the data drivers 130, such as adjacent data drivers, and a second driving voltage pad 143 which is opposite to the first driving voltage pad 141 relative to the display region A and with the display region A interposed therebetween. The second driving voltage pad 143 is elongated along a lateral side of the display region A. As in the illustrated embodiment of FIG. 1, a longitudinal direction of the second driving voltage pad 143 is substantially parallel with a side (e.g., longitudinal side) of the display region A.

The common voltage pads 151 and 153 include a first common voltage pad 151 which is formed between a pair of the gate drivers 120, such as adjacent gate drivers 120, and a second common voltage pad 153 which is opposite to the first common voltage pad 151 relative to the display region A and with the display region A interposed therebetween.

The common voltage pads 151 and 153 are connected with the common electrode and supply a common voltage from the outside to the common electrode. FIGS. 1 and 2 illustrate the common electrode and the common voltage pads 151 and 153 separated from each other. In an alternative embodiment, the common electrode and the common voltage pads 151 and 153 may be connected with each other or connected through a bridge electrode (not shown), such as made of indium tin oxide (“ITO”)

In exemplary embodiments, the driving voltage pads 141 and 143 include a data metal material which forms the data line. The common voltage pads 151 and 153 include a gate metal material which forms the gate line. The voltage pads 141, 143, 151 and 153 may include conductive materials used in the gate and/or data metal material. The voltage pads 141, 143, 151 and 153 may include an of a number of conductive materials suitable for the purpose described herein, including, but not limited to, indium tin oxide (“ITO”) or indium zinc oxide (“IZO”).

The shape and arrangement of the voltage pads 141, 143, 151 and 153 may be varied depending on a supplying amount required for a driving voltage and/or common voltage. IN an exemplary embodiment and according to the size of the display device, the voltage pads 141, 143, 151 and/or 153 may be formed along a side part of the display region A or may be formed between the gate driver 120 and the data driver 130. The voltage pads 141, 143, 151 and/or 153 may also be extended in a bar (e.g., elongated rectilinear) shape towards a lower part of the respective fan-out part.

The printed circuit board 200 supplies the gate voltage and the data voltage to the display region A, and is connected with a lateral side of the insulating substrate 100 formed with the data driver 130. In an exemplary embodiment, the printed circuit board 200 includes a voltage generator (not shown) and a circuit (not shown) to generate various voltages.

After forming the display region A on the insulating substrate 100, the printed circuit board 200 may be folded to a rear part of a display part. In one exemplary embodiment, the printed circuit board 200 may include a flexible film. The gate on/off voltage is supplied to the gate driver 120 through a patterned wire (not shown) which is formed in the insulating substrate 100.

As the illustrated embodiment includes the printed circuit board 200 connected with only one side of a plurality of sides of the insulating substrate 100, various voltages generated by the printed circuit board 200 are transmitted by the printed circuit films 310, 320 and 330 which connect the voltage pads 141, 143, 151 and 153 and the driver 120 to the printed circuit board 200, respectively.

In exemplary embodiment, the common voltage or the driving voltage is supplied to a substrate by using an additional printed circuit board and a printed circuit film, instead of using a gate or data driving IC, thereby supplying the common and driving voltages to the display region A relatively rapidly and uniformly. The printed circuit board may be connected with each of the voltage pads formed in side parts of the display region A. As a result, an overall size of the display device may be undesirably increased and a voltage drop in the common voltage and the driving voltage due to resistance of the plurality of printed circuit boards and the printed circuit films may be produced. In addition, production cost may be increased due to installation of the printed circuit boards and the printed circuit films.

The illustrated embodiment provides the printed circuit films 320 and 330 crossing the display region A to sufficiently supply the common voltage and the driving voltage to the display region A. When power is outputted from the voltage pads 141, 143, 151 and 153 by using the single printed circuit board 200, the common voltage or the driving voltage may be supplied from all around the display region A via the printed circuit films 320 and 330. Advantageously, the common voltage and/or the driving voltage is supplied to the display region A more quickly and uniformly.

In an exemplary embodiment, the printed circuit films 310, 320 and 330 include a first printed circuit film 310 which connects the first driving voltage pad 141 and the data driver 130 to the printed circuit board 200, a second printed circuit film 320 which connects the second driving pad 143 to the printed circuit board 200, and a third printed circuit film 330 which connects the common voltage pads 151 and 153 to the printed circuit board 200.

In an exemplary embodiment, the first printed circuit film 310 may be formed as a plurality of layers to transmit the data voltage and the gate voltage as well as the driving voltage supplied to the first driving voltage pad 141, to the gate driver 120 and the data driver 130.

The second printed circuit film 320 crosses and extends across the display region A along a shorter side (e.g., parallel to a transverse) of the insulating substrate 100 and connects the printed circuit board 200 and the second driving voltage pad 143 opposite the printed circuit board 200 and facing the display region A. The second printed circuit film 320 supplies the driving voltage from the printed circuit board 200 to the second driving voltage pad 143.

As shown in FIG. 1, the second printed circuit film 320 includes a contacting end part 321 which is diverged into fives parts to individually contact the second driving voltage pad 143. The contacting end part 321 is connected with the printed circuit board 200. The single second printed circuit film 320 diverged into several parts is used to uniformly supply the driving voltage to the second driving voltage pad 143 extending along the display region A. In one exemplary embodiment the diverged contacting end parts 321 are integrated at a center part thereof so as to form a substantially uniform resistance by the second driving voltage pad 143 and to transmit the driving voltage with a uniform magnitude as illustrated in FIG. 1. In an alternative embodiment, the contacting end part 321 may vary in arrangement, such as like the printed circuit films 310 and 330. As used herein, “integrated” is used to indicated formed to be a single unit of piece rather than combining separate elements.

The third printed circuit film 330 crosses and extends along a longer (e.g., longitudinal) side of the display region A and connects the first common voltage pad 151 and the second common voltage pad 153. Also, the third printed circuit film 330 connects the common voltage pads 151 and 153 and the printed circuit board 200. The third printed circuit film 330 may contact a single voltage pad 153 in a plurality of contact areas, like the second printed circuit film 320 contacts the second driving voltage page 143. The third printed circuit film 330 may connect the voltage pads 151 and 153 which face each other, with the display region A interposed therebetween. The third printed circuit film 330 may connect the first common voltage pads 151 provided in the same side.

In the illustrated embodiment, the common voltage is supplied to the common voltage pads 151 and 153 through the third printed circuit film 330, and then finally supplied to the common electrode. Alternatively, separate printed circuit films may be provided to connect the first common voltage pad 151 and the printed circuit board 200, and the second common voltage pad 153 and the printed circuit board 200, respectively.

In exemplary embodiments, the second and third printed circuit films 320 and 330 may be formed as a single layer, different from the first printed circuit film 310, since the second and third printed circuit films 320 and 330 supply a single level voltage like the driving voltage or the common voltage.

The number and shape of the printed circuit films 310, 320 and 330 may vary. The printed circuit films 310, 320 and 330 are designed to minimize a resistance between the voltage pads 141, 143, 151 and 153 and maintain the resistance substantially constant.

FIG. 2 illustrates a cross-section of the third printed circuit film 330 contacting the second common voltage pad 153. The exemplary embodiment shown in FIG. 2 is similar to a structure of a cross-section for the different voltage pads and the printed circuit films.

As shown in FIG. 2, a light emitting layer 15, also considered as a “display element,” is formed on the insulating substrate 100. The common electrode (not shown) and the glass layer 110 are sequentially formed on the light emitting layer 15. The common electrode is connected with the second common voltage pad 153 formed in the non-display region of the insulating substrate 100. The second common voltage pad 153 is connected with the third printed circuit film 330 formed on the glass layer 110.

An anisotropic conductive film 301 is formed between the second common voltage pad 153 and the third printed circuit film 330, thereby improving electrical contact efficiency therebetween and lessening a physical shock when an external force may be applied. In an exemplary embodiment, a process of connecting the second common voltage pad 153 to the third printed circuit film 330 may include arranging the anisotropic conductive film 301 with the third printed circuit film 330 on the second common voltage pad 153 and applying pressure thereto, as shown by the single downward arrow over the anisotropic conductive film 301 in FIG. 2. In an exemplary embodiment, the anisotropic conductive film may be formed between the voltage pads and the printed circuit films and/or between the printed circuit film and the circuit board.

The display device of FIGS. 1 and 2 is considered a bottom emission type of display device in which light is emitted from the light emitting layer 15 to a lower part of the insulating substrate 100, i.e., to a rear side of the light emitting layer 15 (e.g., as indicated by the plurality of downward arrows in FIG. 2). Advantageously, the printed circuit films 320 and 330 crossing the display region A are formed on the glass layer 110 and do not to interrupt a light emission.

In an exemplary embodiment, the gate and data drivers 120 and 130, and the voltage pads 141, 143, 151 and 153 are formed on a first side (e.g., an upper side) of the insulating substrate 100 as well as the light emitting layer 15. In the case of the bottom emission type of display device, the printed circuit films 320 and 330 may be coupled with the insulating substrate 100 without being bent to a second side (e.g., a lower side) of the substrate 100. When the printed circuit films 320 and 330 are not bent towards the second side of the substrate 100, a voltage may be supplied relatively quickly and a resistance decreases.

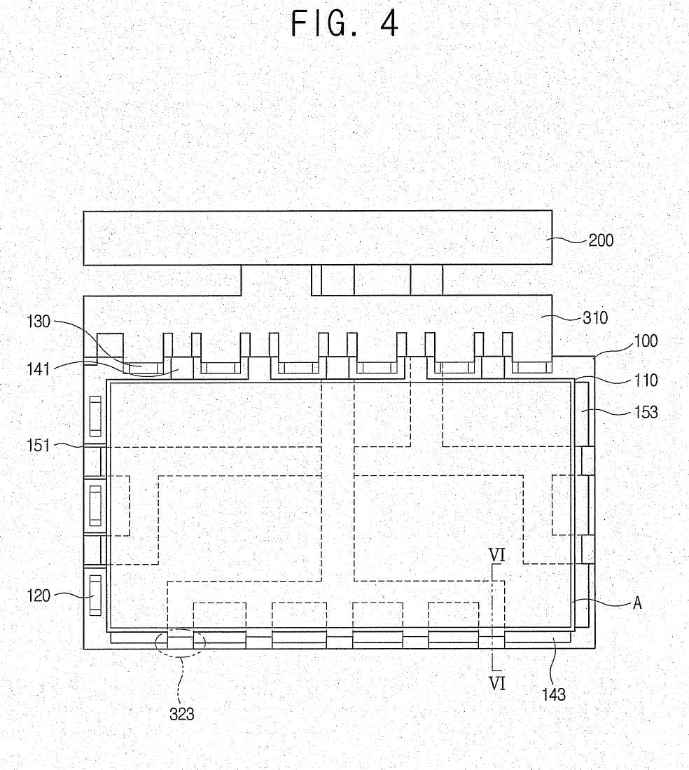

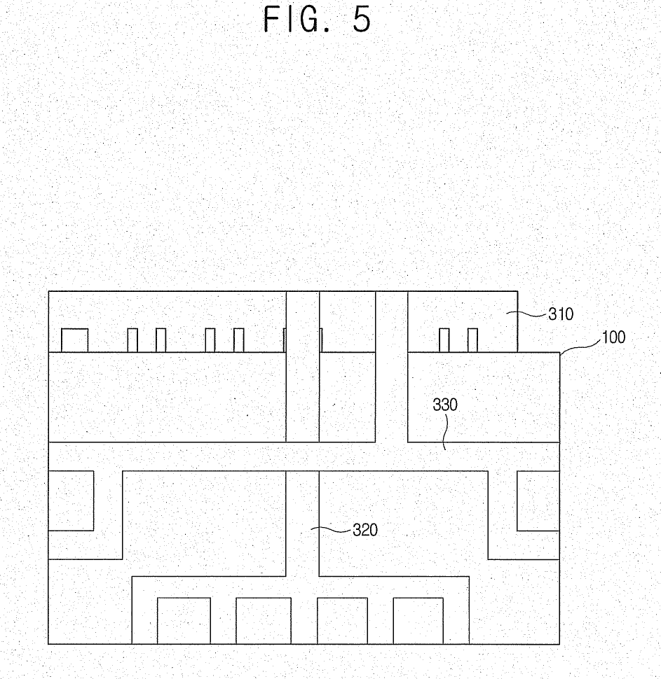

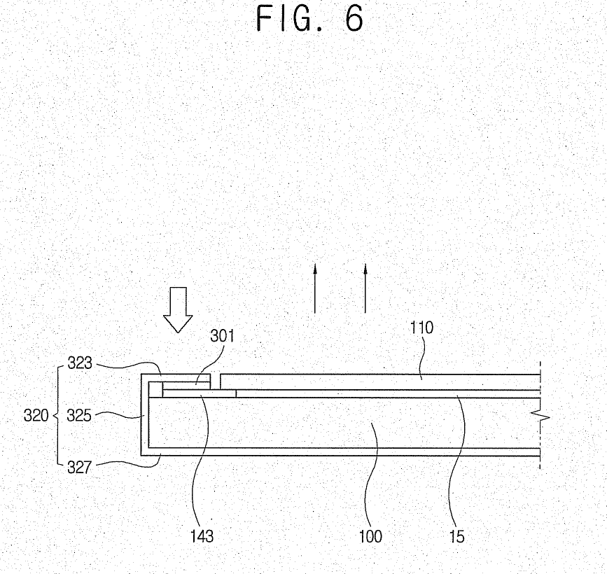

FIG. 4 is a schematic view of another exemplary embodiment of a display device according to the present invention. FIG. 5 is a rear perspective view of the display device of FIG. 4. FIG. 6 is a cross-sectional view of the display device taken along line VI-VI in FIG. 4.

The display device of FIGS. 4-6 adopts a top emission type of display device. As illustrated, printed circuit films 320 and 330 which cross a display region A are connected with a rear part of an insulating substrate 100.

Dotted lines in FIG. 4 illustrate the second and third printed circuit films 320 and 330 formed in the rear part of the insulating substrate 100. As the number and arrangement of the printed circuit films 320 and 330 are similar to those in FIGS. 1 and 2, the description thereof will be omitted here.

As shown in FIG. 6, light which is generated from a light emitting layer 15 is emitted to an upper part of the insulating substrate 100, i.e., toward a glass layer 110, as indicated by the plurality of upward arrows in FIG. 6. The second and third printed circuit films 320 and 330 are arranged in the rear part of the insulating substrate 100.

The second printed circuit film 320 includes a contacting part 323 which contacts the second driving voltage pad 143, a bending part 325 which is bent from the contacting part 323 toward the rear part of the insulating substrate 100, and a signal transmitter 327 which extends from the bending part 325 to the insulating substrate 100 and along a lower surface of the insulating substrate 100. The bending part 325 is provided to arrange the printed circuit film 320 in another side of the insulating substrate 100 from which the light emitting layer 15 is formed (e.g., an opposite side of the insulating substrate), thereby enabling the top emission type of display device.

The illustrated embodiments provide a display device which is efficiently supplied with a driving voltage or a common voltage and provides uniform brightness.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device, comprising:
an insulating substrate including a display region;
a light emitting layer formed within the display region and on the insulating substrate;
a plurality of voltage pads formed in a non-display region of the insulating substrate and supplying a predetermined voltage to the display region;
a circuit board connected with a lateral side of the insulating substrate and outputting a voltage to the voltage pads; and
a printed circuit film connecting the voltage pads and the circuit board and partially overlapping with the display region.

2. The display device according to claim 1, further comprising:
a gate line and a data line formed within the display region, a plurality of gate drivers formed in the non-display region and supplying a gate voltage to the gate line, and a plurality of data drivers formed in the non-display region and supplying a data voltage to the data line,
wherein the gate drivers and the data drivers are formed on the insulating substrate.

3. The display device according to claim 2, wherein a first voltage pad is formed between the plurality of gate drivers, and a second voltage pad is formed between the plurality of data drivers.

4. The display device according to claim 1, wherein at least one of the voltage pads extends along at least one side of the display region.

5. The display device according to claim 4, wherein the printed circuit film contacts at least two parts of each, of the voltage pads.

6. The display device according to claim 2, wherein the printed circuit film connects at least two of the voltage pads.

7. The display device according to claim 1, further comprising:
a driving voltage line formed within the display region, wherein the voltage outputted to the voltage pads comprises a driving voltage supplied to the driving voltage line.

8. The display device according to claim 1, further comprising:
a common electrode formed on an upper surface of the display region, wherein the voltage outputted to the voltage pads comprises a common voltage supplied to the common electrode.

9. The display device according to claim 1, further comprising:
an anisotropic conductive film formed between the voltage pads and the printed circuit film, and between the printed circuit film and the circuit board.

10. The display device according to claim 1, wherein the printed circuit film is formed on a side of the insulating substrate opposite to an emitting direction of light from the light emitting layer.

11. The display device according to claim 10, further comprising:
a glass layer formed on the light emitting layer, wherein the light is emitted from the light emitting layer towards the insulating substrate and the printed circuit film is provided on the glass layer.

12. The display device according to claim 10, further comprising:
a glass layer formed on the light emitting layer, wherein the light is emitted from the light emitting layer towards the glass layer, and the printed circuit film is provided on a rear part of the insulating substrate.

13. The display device according to claim 12, wherein the printed circuit film comprises:
a contacting part contacting the voltage pads,
a bending part bent from the contacting part toward the rear part of the insulating substrate, and
a signal transmitter extending from the bending part along the rear part of the insulating substrate.

14. A display device comprising:
an insulating substrate;
a plurality of voltage pads formed on the insulating substrate and spaced from each other along a circumference of the insulating substrate;
a voltage supplying part connected with the circumference of the insulating substrate and supplying a predetermined voltage to the voltage pads; and
a plurality of voltage transmitting parts connecting the voltage pads and the voltage supplying part.

15. The display device according to claim 14, wherein the voltage transmitting parts comprise a printed circuit film.

16. A display device, comprising:
an insulating substrate including a display region;
a light emitting layer formed within the display region;
a plurality of voltage pads formed in a non-display region of the insulating substrate and supplying a predetermined voltage to the display region;
a circuit board connected to a side part of the insulating substrate and outputting a voltage to be supplied to the voltage pads; and
a printed circuit film simultaneously transmitting the voltage outputted from the circuit board to the plurality of voltage pads.

17. The display device according to claim 16, wherein the printed circuit film connects the voltage pads and the circuit board, and is overlapped with the display region.

18. The display device according to claim 16, wherein the voltage supplied to the voltage pads comprises at least one of a driving voltage and a common voltage.

19. The display device according to claim 16, further comprising:
an anisotropic conductive film provided between the voltage pads and the printed circuit film, and between the printed circuit film and the circuit board.

20. The display device according to claim 16, wherein the printed circuit film is provided on a side of the insulating substrate opposite to an emitting direction of light from the light emitting layer.

21. A method of forming a display device, the method comprising:
forming a light emitting layer in a display region of an insulating substrate;
forming a plurality of voltage pads in a non-display region of the insulating substrate, the plurality of voltage pads supplying a predetermined voltage to the display region;
connecting a circuit board to the non-display region of the insulating substrate, the circuit board outputting a voltage to the voltage pads; and
connecting a printed circuit film between the plurality of voltage pads and the circuit board, the printed circuit film overlapping the display region.

22. The method of claim 21, wherein the connecting a printed circuit film comprises contacting the printed circuit film to at least two parts of each of the voltage pads.
